(19) United States
(12) Patent Application Publication
(10) Pub. No.: US 2026/0103418 A1
(43) Pub. Date: Apr. 16, 2026

(54) MOLD FOR MOLDING GLASS-MADE OPTICAL COMPONENT

(71) Applicant: Okamoto Glass Co., Ltd., Kashiwa-shi (JP)

(72) Inventors: Tomohisa MARU, Kashiwa-shi (JP); Shoji KOTEGAWA, Kashiwa-shi (JP); Satoshi TAKAHASHI, Kashiwa-shi (JP)

(21) Appl. No.: 19/183,921

(22) Filed: Apr. 21, 2025

(30) Foreign Application Priority Data
Oct. 10, 2024 (JP) 2024-178233

(51) Int. Cl. C03B 11/08; C03B 19/02

(52) U.S. Cl. CPC C03B 11/08; C03B 19/025; C03B 2215/71

(57) ABSTRACT

Provided with a glass flow passage mold having a lower mold provided on a female mold and an upper mold provided on a ring mold to connect the female mold, the ring mold and a molding mold having a lower molding mold and an upper molding mold into which molten glass gob is injected. The lower mold of the glass flow passage mold can be integrated with the female mold and detached from the female mold. The upper mold of the glass flow passage mold can be integrated with the ring mold and detached from the ring mold. In addition, the glass flow passage mold can be integrated with the molding mold. The above described features significantly improve the manufacturing yield and the productivity.

### CROSS-REFERENCE TO RELATED APPLICATIONS

This patent specification is based on Japanese patent application, No. 2024-178233 filed on Oct. 10, 2024 in the Japan Patent Office, the entire contents of which are incorporated by reference herein.

### TECHNICAL FIELD

The present invention relates to a mold for molding a glass-made optical component having a precise and complicated three-dimensional shape. Specifically, the present invention relates to a mold for efficiently molding a glass-made optical component (e.g., double-sided aspherical lens, irregular shaped lens) having a precise and complicated three-dimensional shape.

### BACKGROUND OF THE INVENTION

Since various light sources are replaced with LEDs and LDs in recent years, lens-shaped products and optical components become more precise and the shape of them becomes more complicated. Thus, a mold for molding a glass-made optical component suitable for the above described products is required.

Conventionally, as for the mold and the method for molding small glass molded articles such as optical components having a three-dimensional shape, a direct press method, a mold pressing method, a reheat press method and an injection molding method have been mainly tried.

The direct press method is the most typical press technology and achieved by directly introducing molten glass gob into a mold and press-molding the molten glass gob by a press machine. Since the glass gob is directly molded in the shape of the mold by a female mold, a male mold and a ring mold, this method is called as the direct press method. As for the mass production system, the glass is generally molded in the shape of the mold by introducing molten glass gob (a lump of molten glass) which is shear cut (cut by a blade) from the molten glass flowing out from a melting furnace directly into a female mold (concave shape mold located at the lower side of a pair of molds) so that the weight of the molten gob becomes approximately constant according to the product weight and then pressing it by a male mold (convex shape mold located at the upper side of a pair of molds).

In the above described case, a ring mold is arranged on an outer peripheral portion of the male mold. When the male mold is lowered to press the glass gob, the ring mold is lowered a little earlier than the male mold to be fitted to the female mold. Thus, the ring mold has a role of forming the edge of the pressed glass product while guiding the male mold.

The conventional direct press technology has the following disadvantages.

(1) When manufacturing a small precision glass component, it is difficult to control the weight of the molten glass gob constantly, and thus the weight of the glass gob varies widely. Accordingly, the problem is that the precise molding cannot be expected stably. Namely, it is necessary to absorb the variation of the weight of the glass gob by the variation of the thickness or the like of the product in this molding method. Thus, it is difficult to mold the product having high shape accuracy.

(2) In order to obtain a small and thin glass-made optical component, heat of the molten glass gob is rapidly taken by the mold when the molten glass gob is extended in the narrow space of the mold during a pressing process. Accordingly, the problem is that the glass is solidified before the molten glass gob is extended thinly and completely. In case that the size of the glass-made optical component is smaller, the heat amount held by the molten glass gob itself is small from the beginning. Thus, the molten glass gob is cooled quickly during the pressing process. Consequently, the glass may be cracked or broken during a press-molding process, and it is extremely difficult to mold the glass-made optical component having a complicated shape including thin or narrow portion.

(3) The molten glass gob having the temperature of approximately 1,000° C. is molded by the mold having the temperature of approximately 500° C. Although the glass and the mold are prevented from adhering to each other, a kind of molding defect (defect of shape and size) called “sink marks” occurs due to the volume contraction since the molten glass gob is in contact with the mold and quickly cooled and solidified near the surface of the molten glass gob while inside the glass is shrunk and solidified later. Thus, high shape accuracy cannot be obtained.

In order to resolve the above described problems of the direct press method, Patent Literature 1 discloses a mold for molding a glass-made optical component on an outer edge portion of a concave surface, the mold comprising: a female mold which has a lower mold of at least one pair of molding molds; a male mold which has a convex surface combined with a concave surface of the female mold; and a ring mold which is arranged on an outer peripheral portion of the male mold, the ring mold having an upper mold of the at least one pair of molding molds for molding the glass-made optical component, characterized in that molten glass gob introduced into the concave surface of the female mold is configured to be pressed from above by the male mold having the convex surface so that the molten glass gob is injected into a space formed between the lower mold and the upper mold of the at least one pair of molding molds.

On the other hand, the mold that deviates from the direct press method has also been proposed. Patent Literature 2 disclosed by Angle et al. can be realized as a technology combining the mold press method and the injection molding method. Patent Literature 2 relates to a method of manufacturing a glass-made optical component having a three-dimensional shape using a carbon mold, pressing under a non-oxidizing atmosphere with heating, keeping the glass molded product inside the carbon mold without demolding, maintaining heating and pressurizing slowly over a sufficient period of time while cooling to below the glass transition point.

### PRIOR ART

### Patent Documents

[Patent Literature 1] International Patent Application Publication No. WO2019/202816
[Patent Literature 2] U.S. Pat. No. 3,844,755

### SUMMARY OF THE INVENTION

### Problem to be Solved by the Invention

In the conventional mold described in Patent Literature 1, it is general to replace a pair of upper and lower molding molds when changing the shape of the glass-made optical component to be manufactured. However, it is found that the state of the molten glass gob entered in the molding molds changes when only the molding molds are changed. Thus, the shape accuracy is deteriorated and the manufacturing yield is decreased. Therefore, when replacing the molding molds, it is often necessary to remake the entire male mold and ring mold.

On the other hand, in the method disclosed in Patent Literature 2, there are the problems that a special carbon mold should be used and it is impossible to form a glass-made optical component with a complex three-dimensional shape that is an objective of the present invention although small optical components such as a simple lens can be formed.

### Means for Solving the Problems

The purpose of the present invention is to provide a new mold for molding a glass-made optical component capable of molding a glass-made optical component having a precise and complicated three-dimensional shape efficiently and with high manufacturing yield.

In order to solve the above described conventional problems, the present invention is a mold for molding a glass-made optical component having a three-dimensional shape, the mold including: a female mold which has a lower molding mold for molding the glass-made optical component on an outer edge portion of a concave surface of the female mold; a male mold which has a convex surface combined with the concave surface of the female mold; and a ring mold which is arranged on an outer peripheral portion of the male mold, the ring mold having an upper molding mold for molding the glass-made optical component, wherein molten glass gob introduced into the concave surface of the female mold is configured to be pressed from above by the male mold having the convex surface and introduced in a space surrounded by the lower molding mold and the upper molding mold, and a glass flow passage mold having a lower mold and an upper mold is provided to connect the female mold, the ring mold and the molding mold so that the molten glass gob is injected in the molding mold when the molten glass gob is pressed, the lower mold being provided on an outer edge portion of the concave surface of the female mold, the upper mold being provided on the ring mold.

Here, the glass-made optical component having a three-dimensional shape is, for example, double-sided aspherical lens, irregular shaped lens and other optical components having a complicated three-dimensional shape. The present invention can provide a mold capable of molding, for example, a glass-made optical component having grid-shaped grooves on both surfaces without having a flat surface almost at all although that is far more difficult than molding the simple-shaped concave lens and convex lens. The glass-made optical component having a three-dimensional shape is exemplified later with the examples of the mold for the glass-made optical component.

The configuration and function of the mold for the glass-made optical component of the present invention will be explained using FIG. 1. A mold 1 for molding a glass-made optical component of the present invention is comprised of: a female mold 2; a molding mold 4; a ring mold 5; a male mold 6; and a glass flow passage mold 12. A lump of molten glass (molten glass gob) which is a material of the glass-made optical component is introduced into a concave surface 3 of the female mold 2. On the other hand, the male mold 6 has a convex surface, and the male mold 6 is used for pressing the molten glass gob from above. Different from the conventional direct press method, the present invention is not the method of obtaining the molded article by directory transferring the shape of the mold formed by the female mold 2 and the male mold 6, but the present invention is the method where the molten glass gob introduced into the female mold 2 is raised upward along the concave surface 3 of the female mold and reaches the outer edge portion when the molten glass gob is pressed by the male mold 6, and the molten glass is injected and filled into the space between a lower mold (lower molding mold) 4a of a molding mold 4 formed on the outer edge portion and an upper mold (upper molding mold) 4b of the molding mold provided on a lower surface of the ring mold 5 through the glass flow passage mold 12 formed by the lower mold and the upper mold to form the glass-made optical component.

Although a main part of the female mold 2 is the concave surface 3, a lower mold 12a of the glass flow passage mold is provided on the outer edge portion of the concave surface of the female mold, a lower mold 4a of the molding mold is provided on the outer edge portion of the concave surface of the female mold, and an upper mold 12b of the glass flow passage mold and an upper mold 4b of the molding mold are provided on a lower surface side of the ring mold 5. In the conventional mold for the direct press method, a final molded product is press-molded between the female mold and the male mold or among the female mold, the male mold and the ring mold. On the other hand, in the present invention, the press-molding operation between the female mold 2 and the male mold 6 is performed only for making the molten glass gob flow, and thus the molten glass gob is injected into a space 9 formed by the molding mold 4 which is formed by the lower molding mold provided on the outer edge portion of the concave surface of the female mold and the upper molding mold provided on the lower surface of the ring mold through the glass flow passage mold 12 to obtain a final product between the molding molds. Thus, the present invention is completely different from the conventional mold for the direct press method.

Here, the glass flow passage mold is formed by the lower mold and the upper mold. The lower mold of the glass flow passage mold is formed more inward than the molding mold to connect to the lower molding mold provided on the outer edge portion of the female mold. The upper mold of the glass flow passage mold is formed more inward than the molding mold to connect to the upper molding mold provided on the lower surface of the ring mold. Although the molding mold is formed on the outer edge portion of the concave surface of the female mold, the glass flow passage mold is formed at the part that overlaps with the concave surface of the female mold and more inward than the molding mold. Thus, the above described part is referred to as the outer edge portion.

The glass flow passage mold 12 will be explained using FIG. 1. In the mold 1 for molding a glass-made optical component, the point A and the point B are defined as follows.
point A; end point of center line in glass flow path surface of lower mold of glass flow passage mold at female mold side
point B; end point of center line in glass flow path surface of lower mold of glass flow passage mold at molding mold side

The areas SA and SB at the end points of the glass flow passage mold are defined as follows when the female mold is placed horizontally.
SA: area of vertical cross-section (CA) of glass flow passage space passing through point A (cross-sectional area of glass inlet side of glass flow passage mold)
SB: area of vertical cross-section (CB) of glass flow passage space passing through point B (cross-sectional area of glass outlet side of glass flow passage mold)

Here, the vertical cross-section is perpendicular to the vertical cross-section including the center line in the glass flow path surface of the lower mold.

In the present invention, it is found that the glass-made optical component has excellent shape accuracy when a ratio (SA/SB) between a cross sectional area SA of a glass inlet side of the glass flow passage space and a cross sectional area SB of a glass outlet side of the glass flow passage space is within a range of 1.7 to 19.7.

Note that the lower mold 4a of the molding mold 4 for molding the glass-made optical component can be integrated with the female mold by being fitted into the female mold 2, the upper mold 4b of the molding mold 4 can be integrated with the ring mold by being fitted into the ring mold 5, the lower mold 4a of the molding mold can be detached from the female mold 2, the upper mold 4b of the molding mold can be detached from the ring mold 5, the lower mold 4a of the molding mold 4 and the upper mold 4b of the molding mold 4 can be replaced in accordance with the shape of the glass-made optical component. This is because various optical components can be manufactured using the same female mold 2, male mold 6 and ring mold 5. For the same reason, a lower mold 12a of the glass flow passage mold 12 for molding the glass-made optical component can be integrated with the female mold by being fitted into the female mold 2, the upper mold 12b of the glass flow passage mold 12 can be integrated with the ring mold by being fitted into the ring mold 5, the lower mold 12a of the glass flow passage mold 12 can be detached from the female mold 2, the upper mold 12b of the glass flow passage mold 12 can be detached from the ring mold 5, and the lower mold 12a of the glass flow passage mold 12 and the upper mold 12b of the glass flow passage mold 12 can be replaced in accordance with the shape of the glass-made optical component.

Furthermore, once the shapes of the molding mold 4 and the glass flow passage mold 12 are determined, it is possible to form a glass flow passage mold integrated molding mold 13 by integrating the molding mold 4 and the glass flow passage mold 12 as shown in FIG. 2. The glass flow passage mold integrated molding mold 13 is comprised of a lower mold 13a of the glass flow passage mold integrated molding mold and an upper mold 13b of the glass flow passage mold integrated molding mold.

Note that a space 9 formed between the lower mold 4a and the upper mold 4b of the molding mold 4 for molding the glass-made optical component is the space corresponding to the shape of the glass-made optical component. In addition, it is preferable to provide an additional space on the outside of the space so that the molten glass gob can flow into the additional space. Thus, the molten glass gob can be surely injected into the space 9. This is because a gap formed on the space 9 can be prevented and defects in the shape of the glass-made optical component can be prevented.

It is preferable to form a hole (perforation) on at least one of the lower mold 4a and the upper mold 4b of the molding mold 4 for molding the glass-made optical component so that the air pushed out by the molten glass gob is evacuated from the space corresponding to the shape of the glass-made optical component through the hole during the press molding operation. This is because the air existed in the space escapes through the hole when the molten glass gob is injected into the space through the inlet of the molten glass. Thus, it is expected that the dimensional accuracy of the optical component can be improved. In this case, it is preferable that the inner diameter of the hole is 0.1 mm or more and 0.5 mm or less. This is because the above described diameter is sufficient for evacuating the air and sufficiently small to prevent the molten glass from flowing in.

### Effects of the Invention

According to the present invention, it is possible to form the glass-made optical component having a precise and complex three-dimensional shape, which could not be obtained with the conventional mold, with good manufacturing yield and high productivity by using a new mold for molding glass-made optical component. In addition, in the basic embodiment, special mold materials and non-oxidizing atmosphere are not required different from the mold press method and mass production or small-lot and multi-product production can be realized. Thus, the present invention greatly contributes to the industrial development.

### BRIEF DESCRIPTION OF DRAWINGS

FIG. 1 shows an example of a mold for molding a glass-made optical component of the present invention.

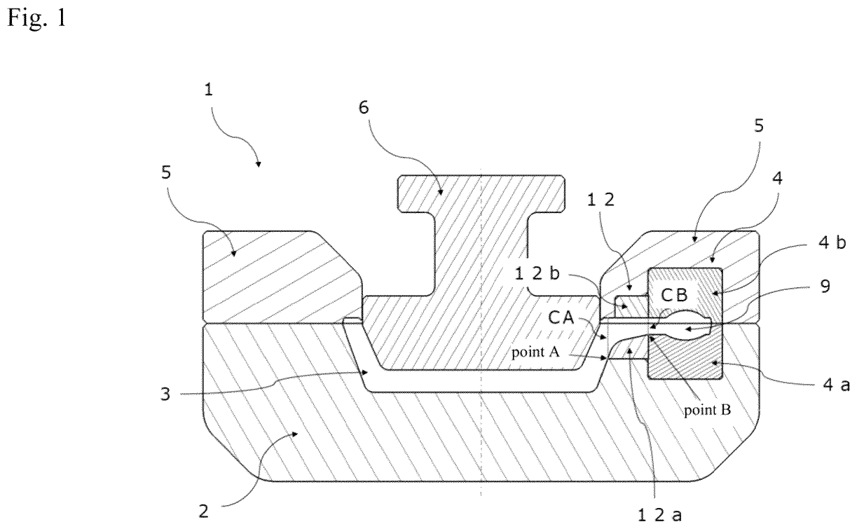

FIG. 2 shows an example where a molding mold and a glass flow passage mold are integrated in the mold for molding the glass-made optical component of the present invention.

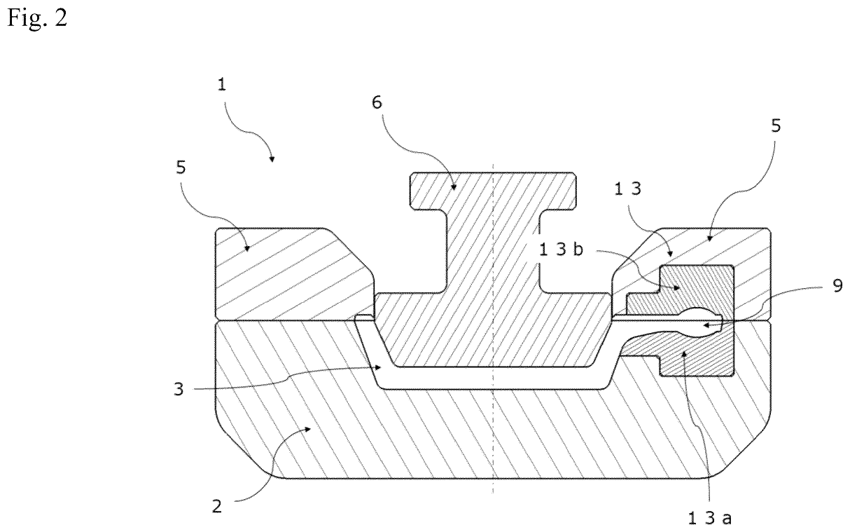

FIGS. 3A to 3C are drawings showing an example of the glass-made optical component manufactured by using the mold for forming the glass-made optical component of the present invention and the cross-sectional area SA of the flow path space of the glass flow passage mold at the glass inlet side and the cross-sectional area SB of the flow path space of the glass flow passage mold at the glass outlet side in the above described case.

FIGS. 4A and 4B are enlarged views of an example of a lower mold of the glass flow passage mold.

FIG. 5 shows an example of the glass-made optical component obtained by using the mold for molding the glass-made optical component of the present invention.

FIG. 6 shows another example of the glass-made optical component obtained by using the mold for molding the glass-made optical component of the present invention.

FIG. 7 shows another example of the glass-made optical component obtained by using the mold for molding the glass-made optical component of the present invention.

### DETAILED DESCRIPTION OF THE INVENTION

The mold for molding a glass-made optical component 1 of the present invention can be produced by cutting and polishing a stainless steel according to a design drawing. A heat-resistant alloy having higher durability can be used for the molding mold 4 if required. The mold for molding the glass-made optical component of the present invention is comprised of a female mold 2, a molding mold 4, a ring mold 5, a male mold 6 and a glass flow passage mold 12. A concave surface 3 is formed on the female mold 2 to introduce a lump of molten glass (molten glass gob) made of a material of the glass-made optical component on the concave surface 3. A lower mold 4a of the molding mold 4 for molding the glass-made optical component is provided on the outer edge portion of the concave surface 3. Furthermore, a lower mold 12a of the glass flow passage mold is formed on the outer edge portion connecting a slope of the concave surface of the female mold and the lower mold 4a of the molding mold.

On the other hand, an upper mold 4b of the molding mold 4 is provided on a lower surface side of the ring mold 5 so that the upper mold 4b is located opposite to the lower mold 4a formed on the outer edge portion of the female mold 2. Furthermore, an upper mold 12b of the glass flow passage mold is provided on the position opposing the lower mold 12a of the glass flow passage mold. When the molten glass gob is introduced into the concave surface 3 of the female mold 2, the ring mold 5 is first lowered and closely in contact with the female mold 2. Thus, a space sandwiched between the lower mold 12a of the glass flow passage mold located at the outer edge portion of the concave surface of the female mold 2, the lower mold 4a of the molding mold 4, the upper mold 12b of the glass flow passage mold located at the lower surface portion of the ring mold 5 and the upper mold 4b of the molding mold. After the ring mold 5 is lowered, the male mold 6 having the convex surface is lowered and the molten glass gob is pressurized from above. The molten glass gob rises along the inner surface of the concave surface 3 of the female mold 2 while maintaining sufficient fluidity to reach the outer edge portion, reaches the end point A of the lower mold 12a of the molten glass flow passage mold, and reaches the end point B (equal to the inlet of the lower mold 4a of the molding mold 4) of the lower mold 12a of the glass flow passage mold while reducing the cross-sectional area (i.e., increasing the flow speed of the molten glass gob). Thus, the glass-made optical component is formed by injecting the molten glass gob into the space sandwiched by the lower mold 4a and the upper mold 4b of the molding mold 4.

It can be considered that the effect of the glass flow passage mold is to appropriately adjust the shape of the molten glass gob and adjust the advancing speed toward the molding mold in the process where the molten glass gob pressed by the male mold 6 rises along the slope of the female mold and finally fills the molding mold. At the inlet (point A) of the glass flow passage mold, the cross-sectional area of the glass gob in the flow path is large and the cross-sectional area becomes smaller toward the direction of the molding mold. From the law of mass conservation, it can be considered that the advancing speed increases as the cross-sectional area becomes smaller. Therefore, it can be considered that the flow of the molten glass gob becomes faster at the outlet (point B) than at the inlet (point A) of the glass flow passage mold, and the molten glass gob fills the space inside the molding mold evenly.

Note that the upper mold 4b of the molding mold 4 can be fixed to the ring mold 5 by, for example, bolt fastening, and has a detachable mold structure. Similarly, also in the female mold 2, the lower mold 4a of the molding mold 4 has a detachable mold structure using bolt fastening or any other arbitrary method (not illustrated). Thus, it is possible to form optical components of various shapes by replacing the lower mold 4a of the molding mold 4 and the upper mold 4b of the forming mold 4 while using the same female mold 2, male mold 6, and ring mold 5. Similar to the molding mold, the lower mold 12a and the upper mold 12b of the glass flow passage mold can also be fixed to the female mold and the ring mold respectively by bolt fastening. Of course, the glass flow passage mold is detachable. The above described features indicate that the present invention is suitable for small-lot and multi-product production.

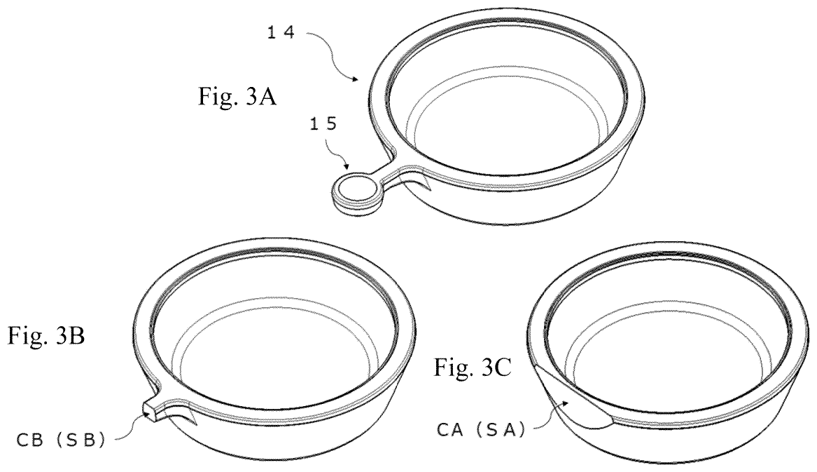

FIG. 3A shows a glass molded body 14 manufactured by using a mold 1 for molding a glass-made optical component of the present invention and a glass-made optical component 15 formed on an end portion of the glass molded body 14. FIG. 3B is the drawing cut at an outlet CB of the glass flow passage mold. The cross-sectional area of CB is SB. On the other hand, FIG. 3C is the drawing cut at an inlet CA of the glass flow passage mold. The cross-sectional area of CA is SA. The part of the glass molded body from CA to CB corresponds to the part with the shape of the flow path of the glass flow passage mold.

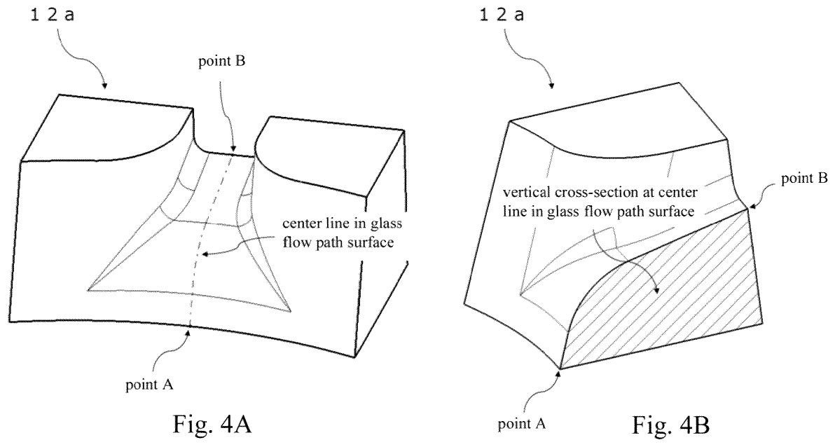

FIGS. 4A and 4B shows only the lower mold of the glass flow passage mold. FIG. 4A is the overall view, and FIG. 4B is a cross-sectional view cut along the center line in the glass flow path surface. It can be seen that a glass flow passage space gradually narrows toward the molding mold. When a center line is drawn in the glass flow path surface, the point where the center line intersects with the end portion of the female mold side of the glass flow passage mold is the point A, and the point where the center line intersects with the end portion of the molding mold side is the point B. In the present invention, it is found that the glass-made optical component has excellent shape accuracy when the ratio (SA/SB) between the cross-sectional area SA of the glass flow passage space at the glass inlet side and the cross-sectional area SB of the glass flow passage space at the glass outlet side is in the range of 1.7 to 19.7.

### Working Examples

Table 1 summarizes the product sizes of various glass optical components manufactured using the mold for molding glass-made optical component of the present invention and the cross-sectional area SA of the glass flow passage mold at the inlet side and the cross-sectional area SB of the glass flow passage mold at the outlet side. X, Y, and Z are the maximum dimensions of the product in each direction.

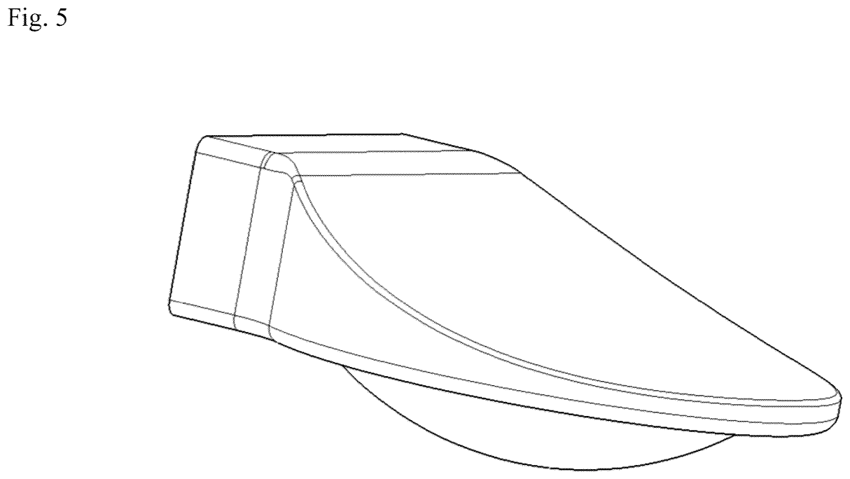

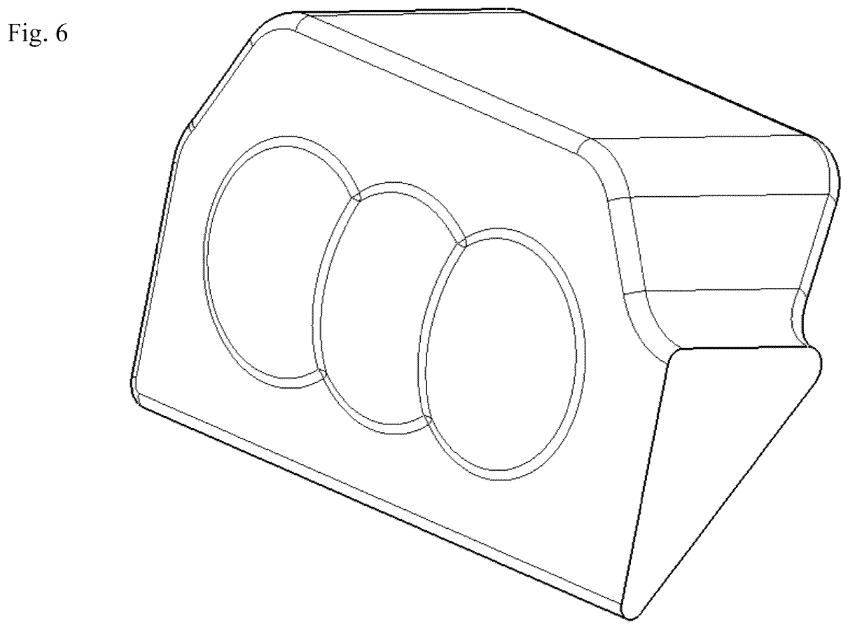

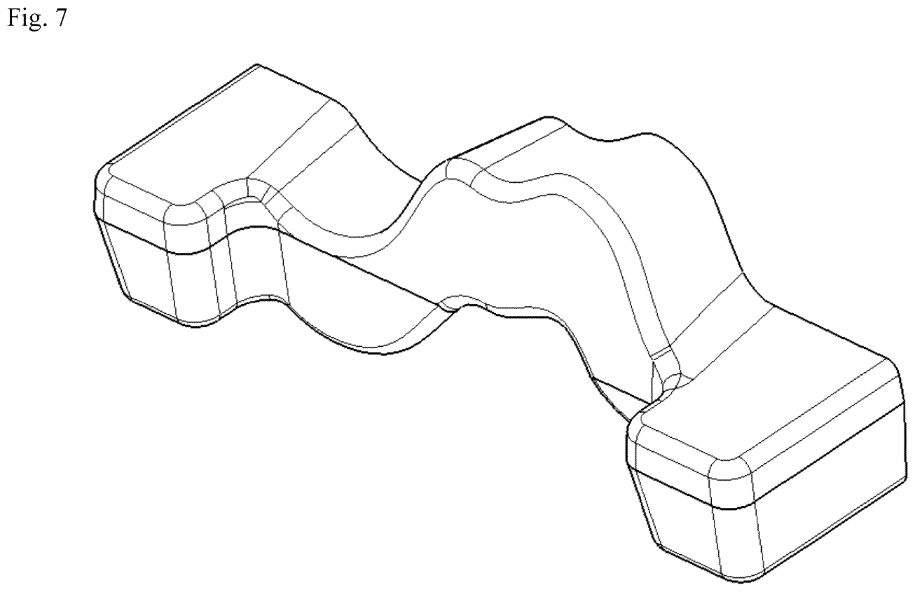

TABLE 1
Working examples, Comparative examples

| | | | | | | ratio of | | |
|---|---|---|---|---|---|---|---|---|
| | | | | cross-sectional | | cross-sectional | | |
| | product size (mm) | | | area (mm²) | | area | molded | drawing |
| product | X | Y | Z | SA | SB | SA/SB | state | example |
| No. 1 | 95.0 | 86.6 | 26.1 | 1360.4 | 1133.4 | 1.2 | underflow | |
| No. 2 | 167.1 | 23.3 | 11.2 | 1726.6 | 1020.1 | 1.7 | good | |
| No. 3 | 42.6 | 43.0 | 15.5 | 1360.4 | 303.5 | 4.5 | good | FIG. 5 |
| No. 4 | 31.0 | 31.0 | 12.0 | 1360.4 | 188.0 | 7.2 | good | |
| No. 5 | 55.2 | 63.0 | 21.0 | 1367.0 | 636.6 | 2.1 | good | |
| No. 6 | 19.2 | 11.0 | 6.2 | 1360.4 | 149.3 | 9.1 | good | FIG. 6 |
| No. 7 | 24.4 | 27.0 | 12.0 | 1363.2 | 108.7 | 12.5 | good | |
| No. 8 | 22.0 | 5.3 | 6.7 | 1360.4 | 98.6 | 13.8 | good | FIG. 7 |
| No. 9 | 23.8 | 24.3 | 7.0 | 1360.4 | 68.9 | 19.7 | good | |
| No. 10 | 22.0 | 24.3 | 7.0 | 1360.4 | 59.1 | 23.0 | cracks, | |
| | | | | | | | breaks | |

When SA/SB is less than 1.7, the molding defects called “underflow” frequently occur. This is the phenomenon where the molten glass gob does not reach every corner of the space inside the molding mold. It is thought that this is because the cross-sectional area does not vary significantly between the inlet (point A) and the outlet (point B) of the glass flow path mold, and thus the inflow speed of the molten glass gob into the space inside the molding mold is slow and the inflow pressure is low. Thus, the molten glass gob is prevented from sufficiently filling the space inside the molding mold.

On the other hand, when SA/SB exceeds 19.7, cracks and breaks frequently occur in the product. It is thought that this is because the cross-sectional area at the point B is significantly smaller compared to the cross-sectional area at the point A in the flow path route of the molten glass gob. Namely, the glass flow passage space narrows too rapidly toward the molding mold. Thus, the inflow speed of the molten glass gob into the space inside the molding mold is too fast and the inflow pressure is too high. Consequently, high pressure is applied on the glass that has flowed into the space inside the molding mold and cracks and breaks occur.

FIG. 5 shows a lens for a vehicle sensing system with one side being a cylindrical surface and the other side being an aspheric surface. FIG. 6 shows a lens for a projector with one of the three surfaces having three spherical surfaces and the remaining two surfaces being cylindrical surfaces, with each of the three surfaces having different shapes. FIG. 7 shows a lens for a vehicle headlight with both the front and back surfaces being free-form spherical surfaces. None of the above described products cannot be formed by the conventional method. Even with the method shown in Patent Literature 1, it is difficult to form the above described products with good manufacturing yield. According to the present invention, the above described products can be manufactured with excellent in terms of forming accuracy and productivity.

### DESCRIPTION OF THE REFERENCE NUMERALS

1: example of mold for molding glass-made optical component of present invention
2: female mold
3: concave surface of female mold
4: molding mold
4a: lower mold of molding mold (lower molding mold)
4b: upper mold of molding mold (upper molding mold)
5: ring mold
6: male mold
9: space formed between molding molds
12: glass flow passage mold
12a: lower mold of glass flow passage mold
12b: upper mold of glass flow passage mold
13: integrated mold formed by integrating molding mold and glass flow passage mold
13a: lower mold of integrated mold
13b: upper mold of integrated mold
14: glass molded body
15: glass-made optical component

1. A mold for molding a glass-made optical component having a three-dimensional shape, the mold comprising:
a female mold which has a lower molding mold for molding the glass-made optical component on an outer edge portion of a concave surface of the female mold;
a male mold which has a convex surface combined with the concave surface of the female mold; and
a ring mold which is arranged on an outer peripheral portion of the male mold, the ring mold having an upper molding mold for molding the glass-made optical component, wherein
molten glass gob introduced into the concave surface of the female mold is configured to be pressed from above by the male mold having the convex surface and injected in a space surrounded by the lower molding mold and the upper molding mold,
a glass flow passage mold having a lower mold and an upper mold is provided to connect the female mold, the ring mold and the molding mold so that the molten glass gob is injected in the molding mold when the molten glass gob is pressed, the lower mold being provided on the outer edge portion of the concave surface of the female mold, the upper mold being provided on the ring mold, and
a ratio (SA/SB) between a cross sectional area SA of a glass inlet side of a glass flow passage space surrounded by the glass flow passage mold and a cross sectional area SB of a glass outlet side of the glass flow passage space is within a range of 1.7 to 19.7 when a point A is defined as an end point of a center line in a glass flow path surface of the lower mold of the glass flow passage mold at the side of the female mold, a point B is defined as another end point of the center line in the glass flow path surface of the lower mold of the glass flow passage mold at the side of the molding mold, SA is defined as an area of a vertical cross-section (CA) of the glass flow passage space passing through the point A, the vertical cross-section being perpendicular to a vertical cross-section including the center line in the glass flow path surface of the lower mold when the female mold is placed horizontally, and SB is defined as an area of a vertical cross-section (CB) of the glass flow passage space passing through the point B, the vertical cross-section being perpendicular to the vertical cross-section including the center line in the glass flow path surface of the lower mold when the female mold is placed horizontally.
